(19) United States
(12) Patent Application Publication
(10) Pub. No.: US 2026/0055837 A1
(43) Pub. Date: Feb. 26, 2026

(54) FLUID CONNECTION ASSEMBLY

(71) Applicant: Oetiker NY, Inc., Lancaster, NY (US)

(72) Inventors: Brett Richard White, Colden, NY (US); James Anthony Kujawski, JR., Attica, NY (US)

(21) Appl. No.: 19/202,072

(22) Filed: May 8, 2025

Related U.S. Application Data
(60) Provisional application No. 63/686,195, filed on Aug. 23, 2024.

(51) Int. Cl. F16L 37/23; F16L 37/30

(52) U.S. Cl. CPC F16L 37/23; F16L 37/30

(57) ABSTRACT

A fluid connection assembly including a plug assembly, including a first end, a second end, a first radially outward facing surface including a first groove, a first through-bore forming a first radially inward facing surface, a first plunger arranged in the first through-bore, and a first spring operatively arranged to bias the first plunger into sealing engagement with the first end, and a socket assembly, including a third end, a fourth end, a second radially outward facing surface including a sleeve translatably arranged thereon, a second through-bore forming a second radially inward facing surface, a hole extending from the second radially outward facing surface to the second radially inward facing surface, a detent arranged in the hole, a second plunger arranged in the second through-bore, a shaft arranged in the second through-bore, and a second spring operatively arranged to bias the second plunger into sealing engagement with the shaft.

### CROSS-SECTION TO RELATED APPLICATIONS

This application claims the benefit under 35 U.S. C. § 119(e) of U.S. Provisional Application No. 63/686,195, filed Aug. 23, 2024, which application is incorporated herein by reference in its entirety.

### FIELD

The present disclosure relates to fluid connectors, and more particularly, to a fluid connection assembly including a retainer that includes a locking sleeve to secure components together.

### BACKGROUND

Fluid connectors, fluid connections, or fluid connection assemblies are integral components for many applications, and especially for refrigerant or cooling systems. Since a cooling system is made up of various components, for example refrigeration lines, compressors, and heat pumps, fluid must be able to travel not only within each component but also between components. Refrigeration lines may carry a refrigerant, which is a substance or mixture, usually a fluid, used in a heat pump and refrigeration cycle, and can be hazardous. As such, it is essential that fluid connectors for refrigeration lines be properly secured so as not to allow the release of any refrigerant.

### SUMMARY

The present disclosure is directed to one or more exemplary embodiments of a fluid connection assembly.

In an exemplary embodiment, the fluid connection assembly comprises a plug assembly, including a first end, a second end, a first radially outward facing surface including a first groove, a first through-bore forming a first radially inward facing surface, a first plunger arranged in the first through-bore, and a first spring operatively arranged to bias the first plunger into sealing engagement with the first end, and a socket assembly, including a third end, a fourth end, a second radially outward facing surface including a sleeve translatably arranged thereon, a second through-bore forming a second radially inward facing surface, one or more holes extending from the second radially outward facing surface to the second radially inward facing surface, a detent arranged in each hole of the one or more holes, a second plunger arranged in the second through-bore, a shaft arranged in the second through-bore, and a second spring operatively arranged to bias the second plunger into sealing engagement with the shaft.

In an exemplary embodiment, the detents are radially displaceable within the one or more holes, and the sleeve is operatively arranged to engage the detents to displace them radially inward from the second radially inward facing surface. In an exemplary embodiment, the fluid connection assembly further comprises a third spring operatively arranged to bias the sleeve into engagement with the detents. In an exemplary embodiment, the spring is engaged with a first axial surface extending radially outward from the second radially outward facing surface and a second axial surface arranged on the sleeve.

In an exemplary embodiment, the second radially outward facing surface comprises a second groove, and a locking ring is engaged with the second groove to prevent displacement of the sleeve in a first axial direction with respect to the second radially outward facing surface. In an exemplary embodiment, the second plunger comprises a third radially outward facing surface including a second groove, a first seal arranged in the second groove to provide a fluid tight seal between the second plunger and the second radially inward facing surface, a third radially inward facing surface including a third groove, and a second seal arranged in the third groove to provide a fluid tight seal between the second plunger and the shaft.

In an exemplary embodiment, the second plunger comprises a recess extending from an end thereof, and the second spring is engaged with the recess. In an exemplary embodiment, the fluid connection assembly further comprises a stopper engaged with the second spring, the stopper including a through-bore engaged with the shaft and a plurality of through-holes circumferentially arranged around the through-bore. In an exemplary embodiment, the stopper is secured in the second through-bore via a securing body.

In an exemplary embodiment, the first plunger comprises a stem portion and a sealing head, wherein the first spring is arranged around the stem portion. In an exemplary embodiment, the fluid connection assembly further comprises a stopper including a through-bore slidingly engaged with the stem portion and a plurality of circumferentially spaced radially outward extending projections. In an exemplary embodiment, the first spring is engaged with the stopper and the sealing head. In an exemplary embodiment, the stem portion comprises an axial surface operatively arranged to engage the stopper to prevent axial displacement of the first plunger with respect to the first radially inward facing surface.

In an exemplary embodiment, the sealing head comprises a third radially outward facing surface arranged at an end of the first plunger, a fourth radially outward facing surface separated from the third radially outward facing surface by a second groove, and a seal arranged in the second groove. In an exemplary embodiment, the third radially outward facing surface comprises a first diameter, the fourth radially outward facing surface comprises a second diameter, and the second diameter is greater than the first diameter. In an exemplary embodiment, the stopper is removably secured to the first radially inward facing surface via a securing body.

In an exemplary embodiment, the first plunger comprises a recess on an end thereof, the shaft comprises a protrusion on an end thereof, and the protrusion is operatively arranged to engage the recess to maintain alignment of the first plunger and/or the shaft during connection. In an exemplary embodiment, in an unconnected state the first plunger is sealingly engaged with the first end, and the second plunger is sealingly engaged with the second radially inward facing surface and the shaft. In an exemplary embodiment, in a connected state the first end displaces the second plunger in a first axial direction such that the second plunger is not sealingly engaged with the shaft, and the shaft displaces the first plunger in a second axial direction, relative to the first axial direction, such that the first plunger is not sealingly engaged with the first end. In an exemplary embodiment, in the connected state the second plunger is sealingly engaged with the second radially inward facing surface.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1A is a front perspective view of a fluid connection assembly.

FIG. 1B is a rear perspective view of the fluid connection assembly shown in FIG. 1A.

FIG. 2 is a front partial exploded perspective view of the fluid connection assembly shown in FIG. 1A.

FIG. 3A is a rear perspective view of the plug assembly shown in FIG. 1A.

FIG. 3B is a front elevational view of the plug assembly shown in FIG. 1A.

FIG. 4 is a cross-sectional view of the plug assembly taken generally along line 4-4 in FIG. 3A.

FIG. 5 is an exploded front perspective view of the plug assembly shown in FIG. 1A.

FIG. 6 is a front perspective view of the socket assembly shown in FIG. 1A.

FIG. 7 is a cross-sectional view of the socket assembly taken generally along line 7-7 in FIG. 6.

FIG. 8 is an exploded front perspective view of the socket assembly shown in FIG. 1A.

FIG. 9A is a front perspective view of a second embodiment of a securing body.

FIG. 9B is a rear perspective view of the securing body shown in FIG. 9A.

FIG. 10 is a cross-sectional view of the fluid connection assembly taken generally along line 10-10 in FIG. 1A.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of: ”is used herein.

It should be appreciated that the term “tube” as used herein is synonymous with hose, pipe, channel, conduit, tube end form, or any other suitable pipe flow used in hydraulics and fluid mechanics. It should further be appreciated that the term “tube” can mean a rigid or flexible conduit of any material suitable for containing and allowing the flow of a gas or a liquid.

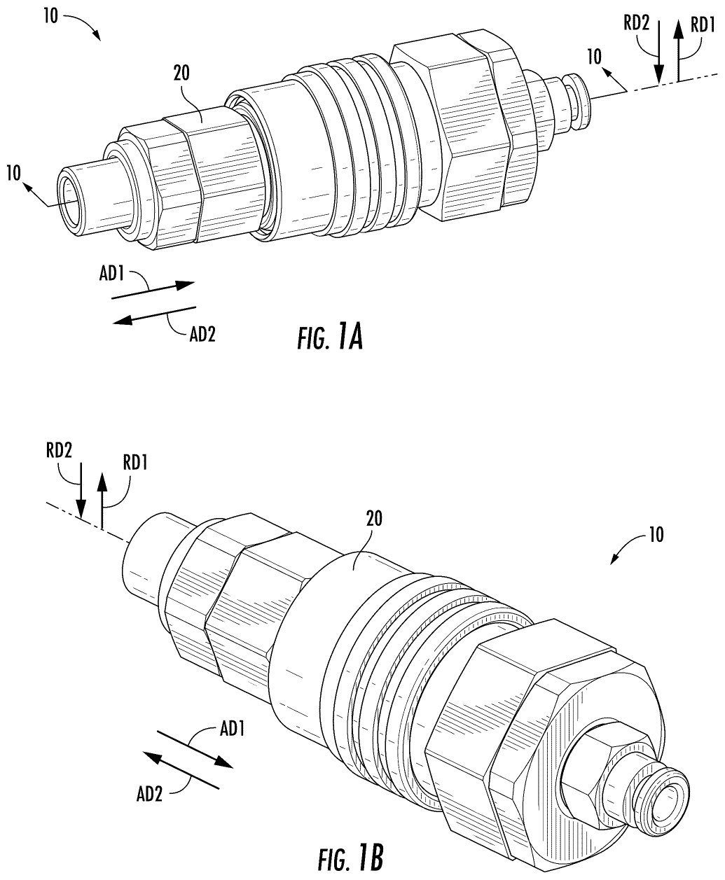

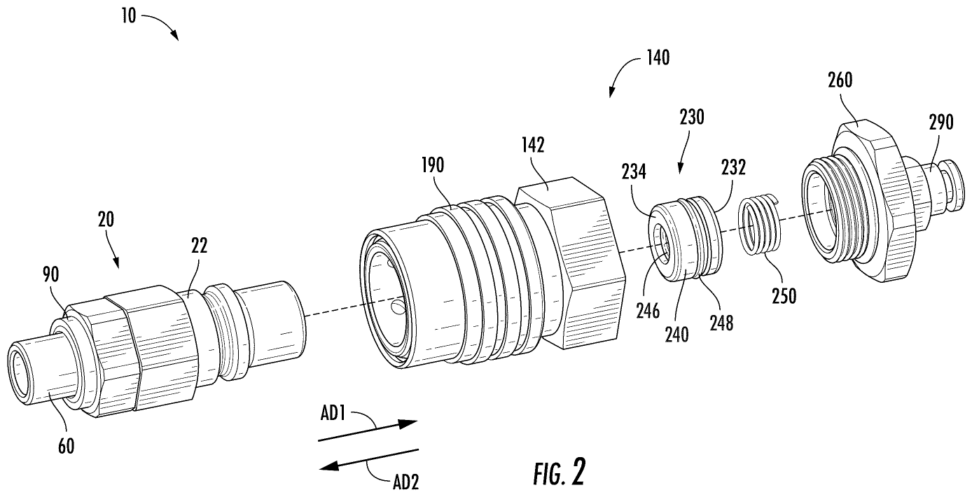

Adverting now to the figures, FIG. 1A is a front perspective view of fluid connection assembly 10. FIG. 1B is a rear perspective view of fluid connection assembly 10. FIG. 2 is a front partial exploded perspective view of fluid connection assembly 10. Fluid connection assembly 10 generally comprises plug assembly 20 and socket assembly 140. In an exemplary embodiment, fluid connection assembly 10 comprises a tube connected or arranged to be connected to at least one of plug assembly 20 and socket assembly 140.

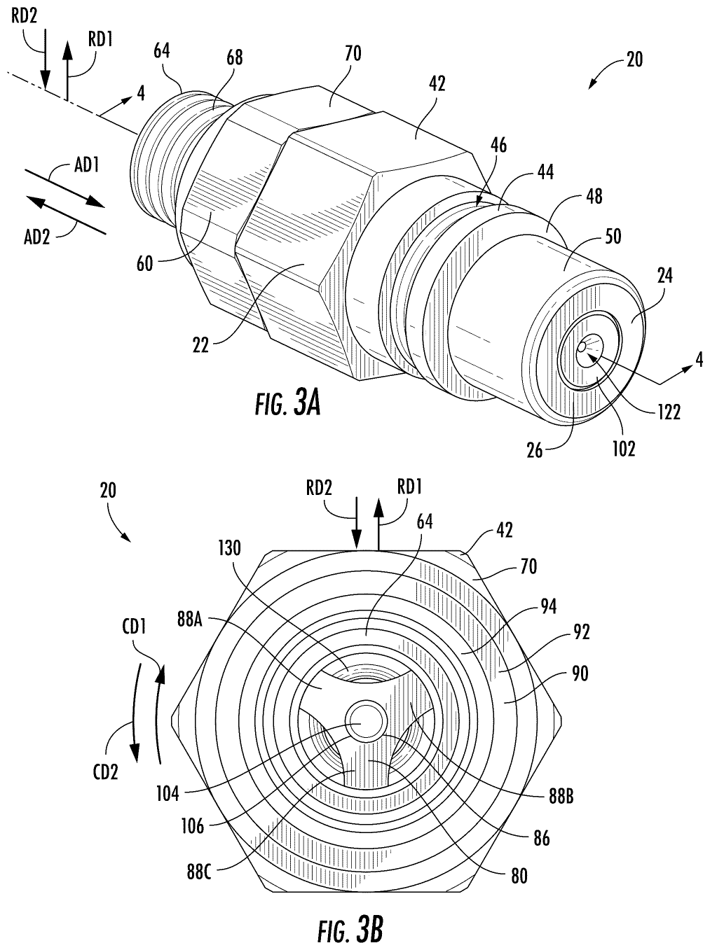

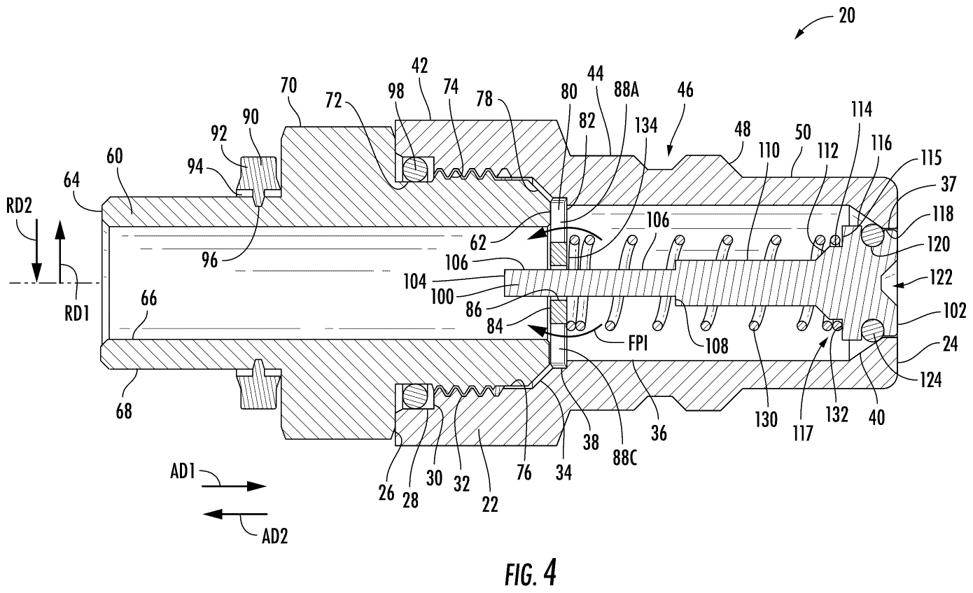

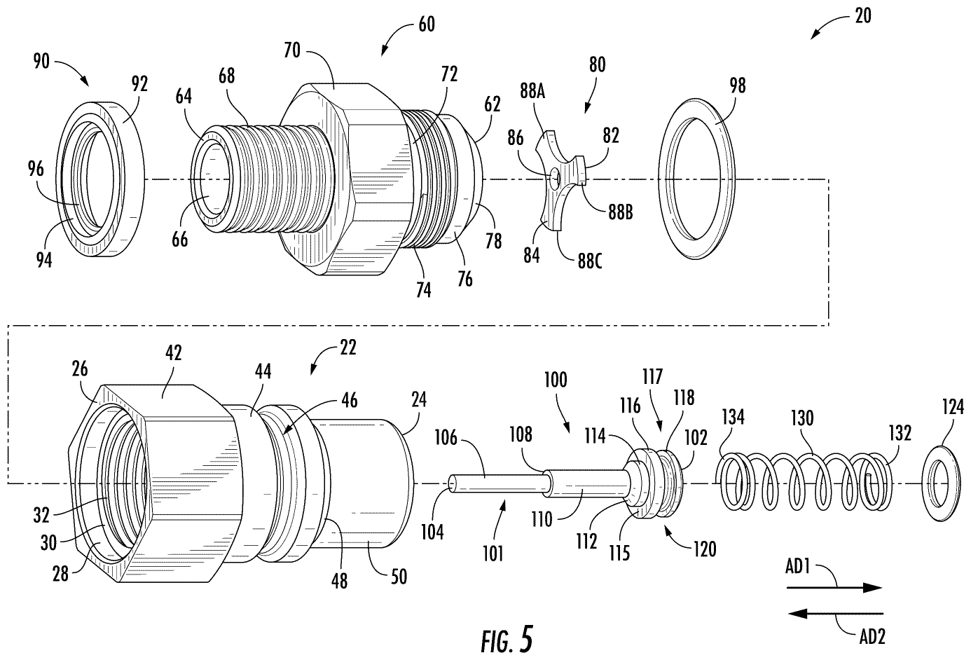

FIG. 3A is a rear perspective view of plug assembly 20. FIG. 3B is a front elevational view of plug assembly 20. FIG. 4 is a cross-sectional view of plug assembly 20 taken generally along line 4-4 in FIG. 3A. FIG. 5 is an exploded front perspective view of plug assembly 20. Plug assembly 20 generally comprises connector body 22, plunger 100, and biasing element or spring 130. In an exemplary embodiment, plug assembly 20 further comprises securing body 60.

Connector body 22 comprises end 24, end 26, at least one radially inward facing surface, for example, radially inward facing surface 28, radially inward facing surface 32, radially inward facing surface 36, and radially inward facing surface 37, and at least one radially outward facing surface, for example, radially outward facing surface 44 and radially outward facing surface 50. Radially inward facing surface 28 extends from end 26 in axial direction AD1 and is connected to radially inward facing surface 32 via axial surface 30. Axial surface 30 extends radially inward from radially inward facing surface 28, and generally faces in axial direction AD2. In an exemplary embodiment, seal 98 is arranged in the recess or groove formed by radially inward facing surface 28 and axial surface 30, to provide a fluid tight seal between connector body 22 and securing body 60. Radially inward facing surface 32 extends from axial surface 30 in axial direction AD1. In an exemplary embodiment, radially inward facing surface 32 is at least partially threaded. Radially inward facing surface 32 is connected to radially inward facing surface 36 via surface 34. In an exemplary embodiment, surface 34 is a frusto-conical surface decreasing in diameter in axial direction AD1. Radially inward facing surface 36 extends from surface 34 in axial direction AD1. In an exemplary embodiment, radially inward facing surface 36 comprises recess or groove 38. Radially inward facing surface 37 extends from end 24 in axial direction AD2 and is connected to radially inward facing surface 36 via surface 40. In an exemplary embodiment, surface 40 is a frusto-conical surface decreasing in diameter in axial direction AD1.

Radially outward facing surface 50 extends in axial direction AD2 and is operatively arranged to engage socket assembly 140. Radially outward facing surface 50 is connected to radially outward facing surface 44 via surface 48. In an exemplary embodiment, surface 48 is a frusto-conical surface increasing in diameter in axial direction AD2. Radially outward facing surface 44 comprises groove 46 operatively arranged to engage with detents or balls 184 to secure plug assembly 20 to socket assembly 140. In an exemplary embodiment, groove 46 comprises a constant diameter radially outward facing surface, a first frusto-conical surface increasing in diameter in axial direction AD1, and a second frusto-conical surface increasing in diameter in axial direction AD2. Connector body 22 further comprises head 42. Connector body 22 may be screwed onto a component, such as securing body 60, via head 42 (e.g., using a wrench). In an exemplary embodiment, head 42 is hexagonal; however, it should be appreciated that head 42 may comprise any geometry suitable for applying torque to connector body 22.

In an exemplary embodiment, plug assembly 20 further comprises stopper 80. Stopper 80 comprises end 82, end 84, through-bore 86, and a plurality of radially outward extending projections circumferentially spaced apart from each other, for example, radially outward extending projections 88A-88C. As best shown in FIG. 4, stopper 80 is arranged in recess or groove 38 such that end 82 abuts against an axial surface of connector body 22. Stopper 80 is secured in recess 38 via securing body 60, namely, end 62. The circumferential spaces between radially outward extending projections 88A-88C allow the flow of fluid through stopper 80, as indicated by flow path arrows FP1 in FIG. 4. Through-bore 86 is operatively arranged to slidingly engage plunger 100. In an exemplary embodiment, stopper 80 is removably connected to connector body 22.

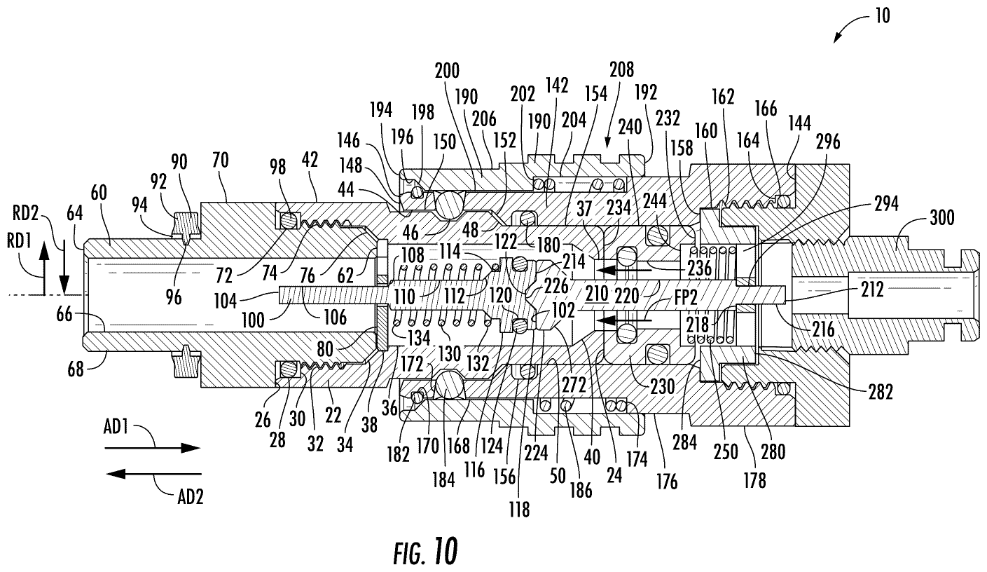

Plunger 100 comprises stem portion 101 and sealing head 117. Specifically, plunger 100 comprises end 102, end 104, and at least one radially outward facing surface, for example, radially outward facing surface 106, radially outward facing surface 110, radially outward facing surface 116, and radially outward facing surface 118. Radially outward facing surface 106 extends from end 104 in axial direction AD1 and is operatively arranged to slidingly engage through-bore 86. Radially outward facing surface 106 is connected to radially outward facing surface 110 via axial surface 108. Axial surface 108 generally faces in axial direction AD2 and is operatively arranged to engage end 82 of stopper 80 to prevent displacement of plunger 100 in axial direction AD2. In an exemplary embodiment, axial surface 108 is a frusto-conical surface increasing in diameter in axial direction AD1. In the closed or unconnected state, as best shown in FIG. 4, surface 108 is spaced apart axially from end 82 by a first distance. In the open state, as best shown in FIG. 10, surface 108 abuts against end 82, or surface 108 is spaced apart axially from end 82 by a second distance, less than the first distance.

Radially outward facing surface 110 is connected to radially outward facing surface 114 via surface 112. In an exemplary embodiment, surface 112 is a frusto-conical surface increasing in diameter in axial direction AD1. Radially outward facing surface 114 is connected to radially outward facing surface 116 via axial surface 115. Radially outward facing surface 118 extends from end 102 in axial direction AD2 and is axially spaced apart from radially outward facing surface 116 via groove 120. Seal 124 is arranged in groove 120. Radially outward facing surfaces 116 and 118, groove 120, and seal 124 form sealing head 117 of plunger 100. In an exemplary embodiment, end 102 further comprises alignment recess 122. Recess 122 is operatively arranged to engage protrusion 226 of shaft 210 such that sealing head 117 does not displace radially with respect to stopper 80.

In an exemplary embodiment, radially outward facing surface 116 comprises a first diameter and radially outward facing surface 118 comprises a second diameter, less than the first diameter. In an exemplary embodiment, the diameter of radially outward facing surface 116 is greater than the diameter of radially inward facing surface 37 to prevent plunger 100 from being removed from connector body 22 in axial direction AD1. This allows plug assembly 20 to be pressurized without the need to be connected to socket assembly 140. For example, when plug assembly 20 is pressurized, the fluid pressure will force plunger 100 in axial direction AD1 and into sealing engagement with connector body 22, namely, surface 40 or end 24.

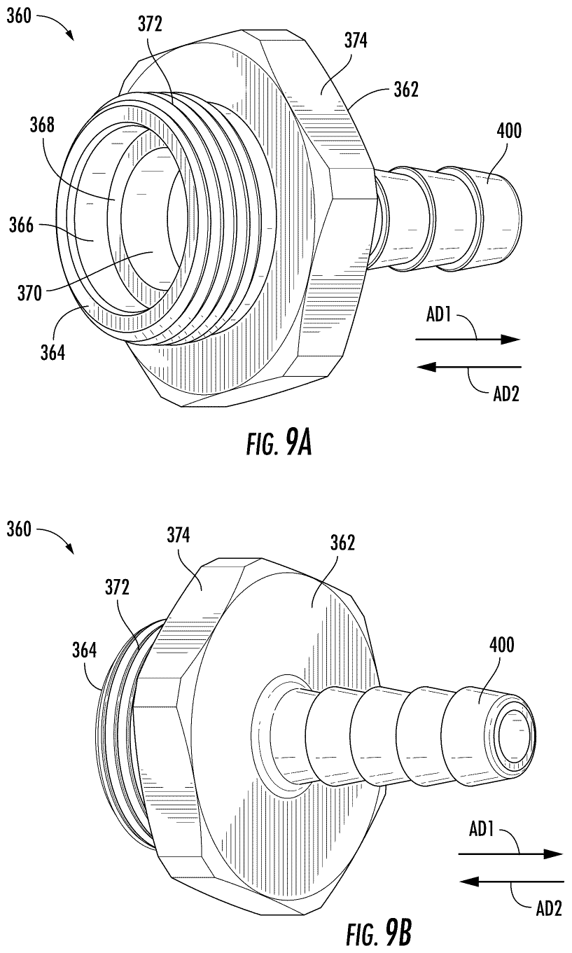

Spring 130 is operatively arranged to bias plunger 100 in axial direction AD1. Spring 130 comprises end 132 arranged to engage sealing head 117 of plunger 100 (e.g., axial surface 115) and end 134 arranged to engage end 82 of stopper 80. Spring 130 biases plunger 100 to the closed state. In the closed state shown in FIG. 4, radially outward facing surface 118 is engaged with radially inward facing surface 37 and seal 124 is engaged with surface 40 and/or radially inward facing surface 37, thereby preventing the flow of fluid into end 24 in axial direction AD2. In the open state shown in FIG. 10, plunger 100 is displaced in axial direction AD2 with respect to connector body 22, for example by shaft 210, such that radially outward facing surface 118 is axially spaced apart from radially inward facing surface 37. This allows fluid to flow into end 24, as indicated by flow path arrows FP2 in FIG. 9.

Securing body 60 comprises end 62, end 64, radially inward facing surface 66, and at least one radially outward facing surface, for example, radially outward facing surface 68 and radially outward facing surface 72. Radially outward facing surface 68 extends from end 64 in axial direction AD1. In an exemplary embodiment, radially outward facing surface 68 is operatively arranged to be connected to a tube or other component, for example, via brazing, a pipe clamp, or another suitable securing means. Radially outward facing surface 72 extends from end 62 in axial direction AD2 and is operatively arranged to engage connector body 22. In an exemplary embodiment, radially outward facing surface 72 is connected to end 62 via frusto-conical surface 78. Frusto-conical surface 78 decreases in diameter in axial direction AD1. In an exemplary embodiment, radially outward facing surface 72 is at least partially threaded, comprising threading 74. In an exemplary embodiment, threading 74 is arranged axially between and spaced apart from head 70 and surface 78. In such embodiment, seal 98 is arranged to engage an unthreaded portion of radially outward facing surface 72.

In an exemplary embodiment, securing body 60 may further comprise head 70 arranged axially between radially outward facing surface 68 and radially outward facing surface 72. Securing body 60 may be screwed onto a component, such as connector body 22, via head 70 (e.g., using a wrench). In an exemplary embodiment, head 70 is hexagonal; however, it should be appreciated that head 70 may comprise any geometry suitable for applying torque to securing body 60.

In an exemplary embodiment, plug assembly 20 further comprises ring assembly 90. Ring assembly 90 comprises outer ring 92 and seal 94 connected to a radially inward facing surface of outer ring 92. Outer ring 92 and seal 94 are arranged concentrically. Seal 94 is operatively arranged to engage radially outward facing surface 68. In an exemplary embodiment, seal 94 comprises radially inward extending flange 96. Flange 96 is arranged axially between and spaced apart from both axial ends of seal 94. In an exemplary embodiment, ring assembly 90 is a seal washer (i.e., a metal washer with a rubber seal).

To assemble plug assembly 20, seal 124 is arranged in groove 120 of plunger 100, and spring 130 is arranged generally around radially outward facing surface 106 and radially outward facing surface 110. Plunger 100 and spring 130 are arranged in connector body 22 and generally aligned with radially inward facing surface 36. Stopper 80 is arranged in connector body 22 such that through-bore 86 engages plunger 100, namely, radially outward facing surface 106. Stopper 80 is arranged in recess 38. Seal 98 is arranged on radially outward facing surface 72 of securing body 60, preferably in the non-threaded portion next to head 70. Securing body 60 is then connected to connector body 22. For example, securing body 60 is connected to connector body 22 via threading 74 and 32. In the connected state, end 62 of securing body 60 is engaged with end 84 to secure stopper 80 in recess 38, and seal 98 is engaged with radially inward facing surface 28.

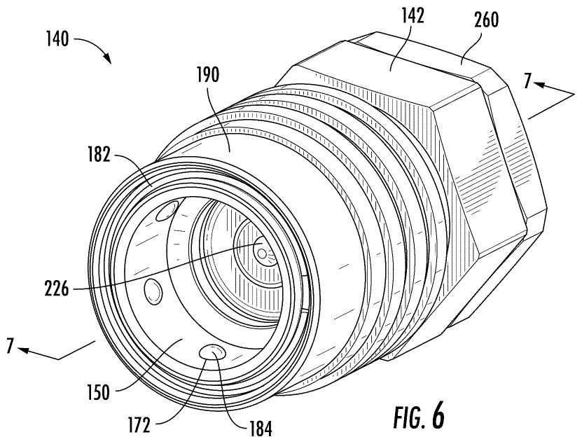

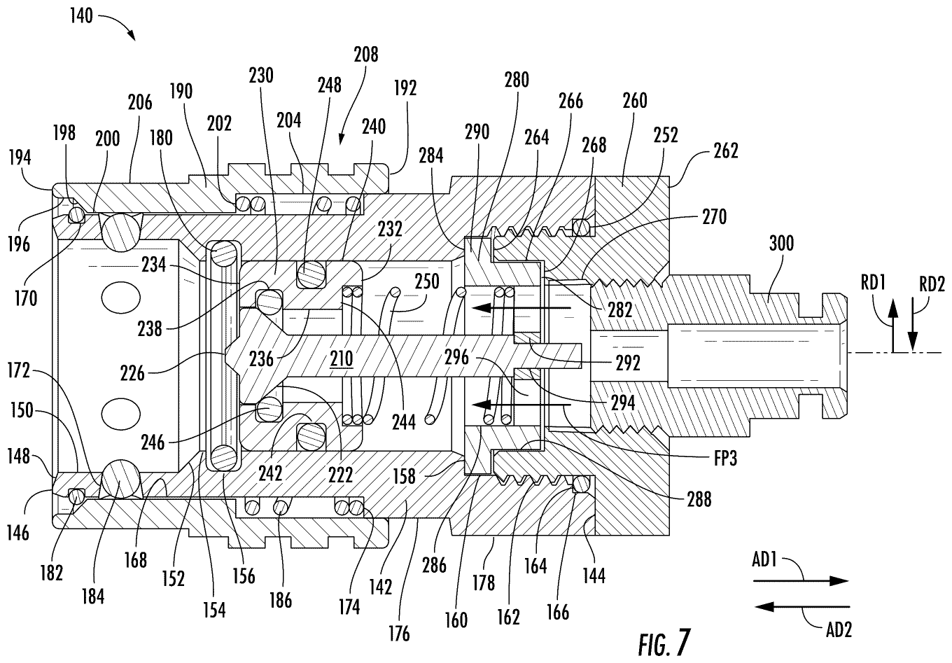

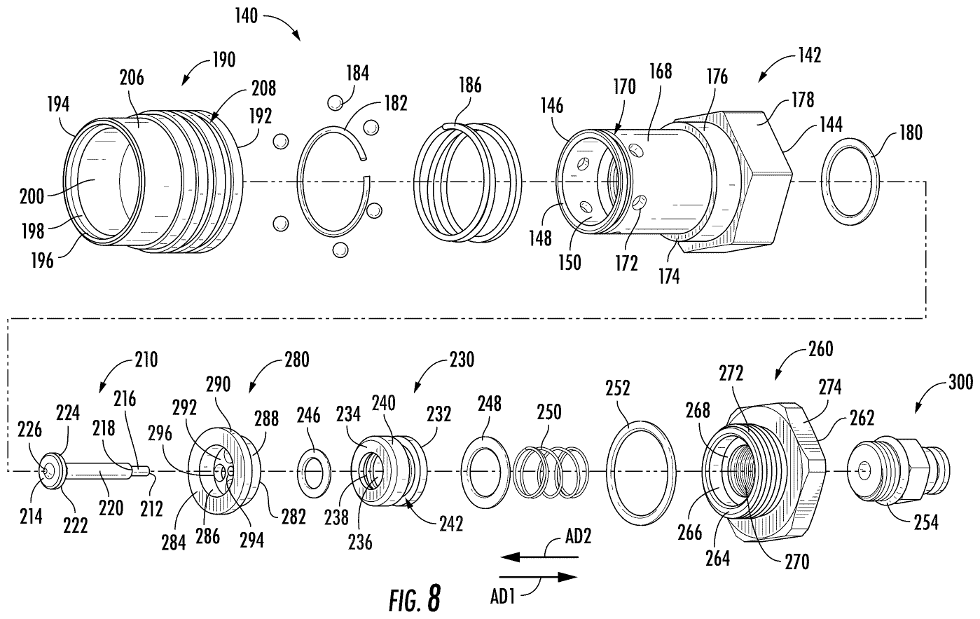

FIG. 6 is a front perspective view of socket assembly 140. FIG. 7 is a cross-sectional view of socket assembly 140 taken generally along line 7-7 in FIG. 6. FIG. 8 is an exploded front perspective view of socket assembly 140. FIG. 10 is a cross-sectional view of fluid connection assembly 10 taken generally along line 10-10 in FIG. 1A. Socket assembly 140 generally comprises connector body 142, sleeve 190, biasing element or spring 186, shaft 210, plunger 230, and biasing element or spring 250. In an exemplary embodiment, socket assembly 140 further comprises securing body 260.

Connector body 142 comprises end 144, end 146, at least one radially inward facing surface, for example, radially inward facing surface 150, radially inward facing surface 154, radially inward facing surface 160, and radially inward facing surface 166, and at least one radially outward facing surface, for example, radially outward facing surface 168 and radially outward facing surface 176. Radially inward facing surface 150 extends from end 146 in axial direction AD1 and is operatively arranged to engage plug assembly 20, namely, radially outward facing surface 50 of connector body 22. In an exemplary embodiment, radially inward facing surface 150 is connected to end 146 via frusto-conical surface 148. Frusto-conical surface 148 increases in diameter in axial direction AD2. Radially inward facing surface 150 is connected to radially inward facing surface 154 via surface 152. In an exemplary embodiment, surface 152 is a frusto-conical surface decreasing in diameter in axial direction AD1. Radially inward facing surface 154 comprises groove 156 within which seal 180 is arranged. Radially inward facing surface 154 is connected to radially inward facing surface 160 via axial surface 158. Axial surface 158 faces generally in axial direction AD1 and extends radially outward from radially inward facing surface 154. Radially inward facing surface 160 is at least partially threaded, including threading 162. In an exemplary embodiment, threading 162 is spaced apart from axial surface 158, thereby forming an unthreaded portion of radially inward facing surface 160 that engages projection 290 of stopper 280. Radially inward facing surface 166 extends from end 144 in axial direction AD2 and is connected to radially inward facing surface 160 via axial surface 164. Axial surface 164 faces generally in axial direction AD1. Radially inward facing surface 166 is operatively arranged to engage seal 252 to create a fluid tight seal between connector body 142 and securing body 260.

Radially outward facing surface 168 extends from end 146 in axial direction AD1 and is connected to radially outward facing surface 176 via axial surface 174. In an exemplary embodiment, and as best shown in FIGS. 7 and 9, radially outward facing surface 168 is connected to end 146 via a frusto-conical surface that decreases in diameter in axial direction AD2. Axial surface 174 extends radially outward from radially outward facing surface 168 and engages spring 186, as will be described in greater detail below. Radially outward facing surface 168 comprises annular groove 170. Locking ring 182 is arranged in groove 170 to prevent sleeve 190 from being removed from connector body 142. In an exemplary embodiment, groove 170 is arranged proximate to, and spaced apart axially from, end 146. In an exemplary embodiment, locking ring 182 is a non-continuous ring having a first circumferential end and a second circumferential end.

Connector body 142 comprises a plurality of circumferentially spaced through-holes 172 extending from radially outward facing surface 168 to radially inward facing surface 150. Detents 184 are arranged in respective holes 172 and are arranged to extend radially inward from radially inward facing surface 150 to engage groove 46 of connector body 22 to secure plug assembly 20 to socket assembly 140. Detents 184 are displaceable with respect to holes 172. Specifically, sleeve 190 is aligned with detents 184 to force detents 184 radially inward to form the connected state (i.e., plug assembly 20 is connected to socket assembly 140 as shown in FIG. 10). When sleeve 190 is displaced in axial direction AD1 out of alignment with detents 184, detents are capable of being displaced radially outward such that plug assembly 20 can be removed from socket assembly 140, as will be described in greater detail below. In an exemplary embodiment, through-holes 172 are frusto-conical such that they decrease in diameter in a radially inward direction, namely, radial direction RD2. As best shown in FIG. 7, each of holes 172 has a first diameter at radially inward facing surface 150 and a second diameter at radially outward facing surface 168 greater than the first diameter. The first diameter is less than the diameter of detents 184, which prevents detents 184 from falling radially inward through holes 172 and into connector body 142.

In an exemplary embodiment, connector body 142 may further comprise head 178 extending from end 144. Connector body 142 may be screwed onto a component, such as securing body 260, via head 178 (e.g., using a wrench). In an exemplary embodiment, head 178 is hexagonal; however, it should be appreciated that head 178 may comprise any geometry suitable for applying torque to connector body 142.

Sleeve 190 is arranged concentrically around connector body 142 and comprises end 192, end 194, at least one radially inward facing surface, for example, radially inward facing surface 196, radially inward facing surface 200, and radially inward facing surface 204, and radially outward facing surface 206. Radially inward facing surface 196 extends from end 194 and is connected to radially inward facing surface 200 via surface 198. In an exemplary embodiment, surface 198 is a frusto-conical surface decreasing in diameter in axial direction AD1. Surface 198 is operatively arranged to engage with locking ring 182 to prevent sleeve 190 from being displaced in axial direction AD2 with respect to connector body 142 (i.e., locking ring 182 prevents removal of sleeve 190 from connector body 142). Radially inward facing surface 200 is connected to radially inward facing surface 204 via axial surface 202. Axial surface 202 faces generally in axial direction AD1 and is operatively arranged to engage spring 186. In an exemplary embodiment, radially outward facing surface 206 comprises a plurality of ridges and/or grooves 208 to help with gripping and displacing sleeve 190.

Spring 186 is arranged concentrically around connector body 142 and aligned with radially outward facing surface 168 such that a first end thereof engages axial surface 174 and a second end thereof engages axial surface 202. As such, spring 186 biases sleeve 190 in axial direction AD2 with respect to connector body 142. Specifically, spring 186 biases sleeve 190 into engagement with detents 184.

In an exemplary embodiment, socket assembly 140 further comprises stopper 280. Stopper 280 comprises end 282, end 284, radially inward facing surface 286, and radially outward facing surface 288. Radially outward facing surface 288 comprises radially outward extending projection 290 arranged proximate to or at end 284. Projection is operatively arranged to engage axial surface 158 to prevent stopper 280 from being displaced in axial direction AD2 with respect to connector body 142, and end 264 of securing body 260 to prevent stopper from being displaced in axial direction AD1 with respect to connector body 142. Stopper 280 further comprises wall 292 arranged at end 282. Wall 292 comprises through-bore 294 operatively arranged to engage shaft 210. Wall 292 further comprises a plurality of through-holes 296 circumferentially spaced around through-bore 294. Through-holes 296 allow fluid to flow through stopper 280, as indicated by flow path arrows FP3 in FIG. 7. In an exemplary embodiment, stopper 280 is removably connected to connector body 142.

Shaft 210 comprises end 212, end 214, and at least one radially outward facing surface, for example, radially outward facing surface 216, radially outward facing surface 220, and radially outward facing surface 224. Radially outward facing surface 216 extends from end 212 in axial direction AD2 and is connected to radially outward facing surface 220 via axial surface 218. Axial surface 218 faces generally in axial direction AD1 and is operatively arranged to engage wall 292 to prevent shaft from being displaced in axial direction AD1 with respect to connector body 142. Radially outward facing surface 220 is connected to radially outward facing surface 224 via surface 222. In an exemplary embodiment, surface 222 is a frusto-conical surface increasing in diameter in axial direction AD2. Radially outward facing surface 224 extends from end 214 in axial direction AD1 and is operatively arranged to engage radially inward facing surface 236 of plunger 230. In an exemplary embodiment, end 214 further comprises alignment protrusion 226. Protrusion 226 is operatively arranged to engage recess 122 of plunger 100 such that sealing head 117 and/or shaft 210 do not displace radially.

Plunger 230 is arranged in connector body 142 and is slidably displaceable with respect thereto. Plunger 230 comprises end 232, end 234, radially inward facing surface 236, and radially outward facing surface 240. Radially inward facing surface 236 comprises groove 238 in which seal 246 is arranged. Radially outward facing surface 240 comprises groove 242 in which seal 248 is arranged. In an exemplary embodiment, groove 238 is arranged proximate to end 234 and groove 242 is arranged proximate to end 232. As shown in FIG. 7, plunger further comprises recess 244 extending from end 232 in axial direction AD2. Recess 244 is operatively arranged to engage spring 250.

In an exemplary embodiment, the diameter of radially inward facing surface 236 is less than the diameter of radially outward facing surface 224 to prevent plunger 230 from being removed from shaft 210 in axial direction AD2. This allows socket assembly 140 to be pressurized without the need to be connected to socket assembly 140. For example, when socket assembly 140 is pressurized, the fluid pressure will force plunger 230 in axial direction AD2 and into sealing engagement with shaft 210.

Spring 250 is arranged concentrically around shaft 210 and has a first end engaged with wall 292 of stopper 280 and a second end engaged with recess 244 of plunger 230. Spring 250 is operatively arranged to bias plunger 230 in axial direction AD2. Spring 250 biases plunger 230 toward a closed state. In the closed state shown in FIG. 7, radially inward facing surface 236 is engaged with radially outward facing surface 224 and seal 246 is engaged with surface 222, thereby preventing the flow of fluid through plunger 230 in axial direction AD2. In the open state shown in FIG. 10, plunger 230 is displaced in axial direction AD1 with respect to shaft 210, for example by end 24 of connector body 22, such that radially inward facing surface 236 is spaced apart from radially outward facing surface 224. This allows fluid to flow into end 24, as indicated by flow path arrows FP2.

Securing body 260 comprises end 262, end 264, at least one radially inward facing surface, for example, radially inward facing surface 266 and radially inward facing surface 270, and radially outward facing surface 272. Radially inward facing surface 266 extends from end 264 and is arranged to engage radially outward facing surface 288 of stopper 280. Radially inward facing surface 266 is connected to radially inward facing surface 270 via axial surface 268. Axial surface 268 extends radially inward from radially inward facing surface 266 and is operatively arranged to engage end 282 of stopper 280. Radially inward facing surface 270 extends from end 262 in axial direction AD2. In an exemplary embodiment, radially inward facing surface 270 comprises threading.

Radially outward facing surface 272 extends from end 264 in axial direction AD1. In an exemplary embodiment, radially outward facing surface 272 is at least partially threaded. In an exemplary embodiment, threading 272 is spaced apart from head 274. In such embodiment, seal 252 is arranged to engage an unthreaded portion of radially outward facing surface 272.

In an exemplary embodiment, securing body 260 may further comprise head 274 arranged at end 262. Securing body 260 may be screwed onto a component, such as connector body 142, via head 274 (e.g., using a wrench). In an exemplary embodiment, head 274 is hexagonal; however, it should be appreciated that head 274 may comprise any geometry suitable for applying torque to securing body 260.

Securing body 260 is operatively arranged to be fluidly connected to a tube or other component. In an exemplary embodiment, socket assembly 140 further comprises fitting 300. Fitting 300 is operatively arranged to be connected to a tube or other component for example, via brazing, a pipe clamp, quick connect, retaining ring, or another suitable securing means. Fitting 300 comprises a radially outward facing surface having threading operatively arranged to engage threading of radially inward facing surface 270. As such, fitting 300 can be screwed into securing body 260 to connect the two components. Seal 254 is arranged between fitting 300 and securing body 260 to provide a fluid seal therebetween.

FIG. 9A is a front perspective view of securing body 360. FIG. 9B is a rear perspective view of securing body 360. Securing body 360 comprises end 362, end 364, at least one radially inward facing surface, for example, radially inward facing surface 366 and radially inward facing surface 370, and radially outward facing surface 372. Radially inward facing surface 366 extends from end 364 in axial direction AD1 and is arranged to engage radially outward facing surface 288 of stopper 280. Radially inward facing surface 366 is connected to radially inward facing surface 370 via axial surface 368. Axial surface 368 extends radially inward from radially inward facing surface 366 and is operatively arranged to engage end 282 of stopper 280.

Radially outward facing surface 372 extends from end 364 in axial direction AD1. In an exemplary embodiment, radially outward facing surface 372 is at least partially threaded. In an exemplary embodiment, threading 372 is spaced apart from head 374. In such embodiment, seal 252 is arranged to engage an unthreaded portion of radially outward facing surface 372.

In an exemplary embodiment, securing body 360 may further comprise head 374 arranged at end 362. Securing body 360 may be screwed onto a component, such as connector body 142, via head 374 (e.g., using a wrench). In an exemplary embodiment, head 374 is hexagonal; however, it should be appreciated that head 374 may comprise any geometry suitable for applying torque to securing body 360.

Securing body 360 is operatively arranged to be fluidly connected to a tube or other component. In an exemplary embodiment, socket assembly 140 further comprises fitting 400. Fitting 400 is operatively arranged to connect securing body 360 to a tube or other component for example, via brazing, a pipe clamp, quick connect, retaining ring, or another suitable securing means. Fitting 400 comprises a radially outward facing surface having a plurality of grooves or ridges. In an exemplary embodiment, fitting or spigot 400 and securing body 360 are integrally formed.

To assemble socket assembly 140, spring 186 is arranged around connector body 142 and aligned with radially outward facing surface 168. Detents 184 are arranged in holes 172. Sleeve 190 is arranged on connector body 142 and aligned with radially outward facing surface 168 such that spring 186 is engaged with axial surface 174 and axial surface 202. Locking ring 182 is then arranged in groove 170, thereby securing sleeve 190 to connector body 142. Seal 180 is arranged in groove 156.

Seal 246 is arranged in groove 238 and seal 248 is arranged in groove 242. Plunger 230 is arranged around shaft 210, spring 250 is arranged around shaft 210 and engaged with recess 244 of plunger 230, and shaft 210 is engaged with through-bore 294 of stopper 280 such that wall 292 engages spring 250. Shaft 210, plunger 230, spring 250, and stopper 280 are inserted into connector body 142 such that radially outward facing surface 240 of plunger 230 is engaged with radially inward facing surface 154 and projection 290 is engaged with axial surface 158 and radially inward facing surface 160. Seal 252 is arranged on securing body 260, 360, and securing body 260, 360 is connected to connector body 142. In an exemplary embodiment, fitting 300 is then connected to securing body 260.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Fluid connection assembly
20 Plug assembly
22 Connector body
24 End
26 End
28 Radially inward facing surface
30 Axial surface
32 Radially inward facing surface
34 Surface
36 Radially inward facing surface
37 Radially inward facing surface
38 Groove or recess
40 Surface
42 Head
44 Radially outward facing surface
46 Groove
48 Surface
50 Radially outward facing surface
60 Securing body
62 End
64 End
66 Radially inward facing surface
68 Radially outward facing surface
70 Head
72 Radially outward facing surface
74 Threading
76 Radially outward facing surface
78 Surface
80 Stopper
82 End
84 End
86 Through-bore
88A Projection
88B Projection
88C Projection
90 Ring assembly
92 Outer ring
94 Seal
96 Flange
98 Seal
100 Plunger
102 End
104 End
106 Radially outward facing surface
108 Axial surface
110 Radially outward facing surface
112 Surface
114 Radially outward facing surface
115 Axial surface
116 Radially outward facing surface
117 Sealing head
118 Radially outward facing surface
120 Groove
122 Recess
124 Seal
130 Spring
132 End
134 End
140 Socket assembly
142 Connector body
144 End
146 End
148 Surface
150 Radially inward facing surface
152 Surface
154 Radially inward facing surface
156 Groove
158 Axial surface
160 Radially inward facing surface
162 Threading
164 Axial surface
166 Radially inward facing surface
168 Radially outward facing surface
170 Groove
172 Through-holes
174 Axial surface
176 Radially outward facing surface
178 Head
180 Seal
182 Locking ring
184 Detents or balls
186 Spring
190 Sleeve
192 End
194 End
196 Radially inward facing surface
198 Surface
200 Radially inward facing surface
202 Axial surface
204 Radially inward facing surface
206 Radially outward facing surface
208 Grooves
210 Shaft
212 End
214 End
216 Radially outward facing surface
218 Axial surface
220 Radially outward facing surface
222 Surface
224 Radially outward facing surface
226 Protrusion
230 Plunger
232 End
234 End
236 Radially inward facing surface
238 Groove
240 Radially outward facing surface
242 Groove
244 Recess
246 Seal
248 Seal
250 Spring
252 Seal
254 Seal
260 Securing body
262 End
264 End
266 Radially inward facing surface
268 Axial surface
270 Radially inward facing surface
272 Radially outward facing surface
274 Head
280 Stopper
282 End
284 End
286 Radially inward facing surface
288 Radially outward facing surface
290 Projection
292 Wall
294 Through-hole
296 Through-holes
300 Fitting
360 Securing body
362 End
364 End
366 Radially inward facing surface
368 Axial surface
370 Radially inward facing surface
372 Radially outward facing surface
374 Head
400 Fitting
AD1 Axial direction
AD2 Axial direction
CD1 Circumferential direction
CD2 Circumferential direction
FP1 Flow path
FP2 Flow path
FP3 Flow path
RD1 Radial direction
RD2 Radial direction

What is claimed is:

1. A fluid connection assembly, comprising:
a plug assembly, including:
a first end;
a second end;
a first radially outward facing surface including a first groove;
a first through-bore forming a first radially inward facing surface;
a first plunger arranged in the first through-bore; and
a first spring operatively arranged to bias the first plunger into sealing engagement with the first end; and
a socket assembly, including:
a third end;
a fourth end;
a second radially outward facing surface including a sleeve translatably arranged thereon;
a second through-bore forming a second radially inward facing surface;
one or more holes extending from the second radially outward facing surface to the second radially inward facing surface;
a detent arranged in each hole of the one or more holes;
a second plunger arranged in the second through-bore;
a shaft arranged in the second through-bore; and
a second spring operatively arranged to bias the second plunger into sealing engagement with the shaft.

2. The fluid connection assembly as recited in claim 1, wherein:
the detents are radially displaceable within the one or more holes; and
the sleeve is operatively arranged to engage the detents to displace them radially inward from the second radially inward facing surface.

3. The fluid connection assembly as recited in claim 2, further comprising a third spring operatively arranged to bias the sleeve into engagement with the detents.

4. The fluid connection assembly as recited in claim 3, wherein the spring is engaged with a first axial surface extending radially outward from the second radially outward facing surface and a second axial surface arranged on the sleeve.

5. The fluid connection assembly as recited in claim 1, wherein:
the second radially outward facing surface comprises a second groove; and
a locking ring is engaged with the second groove to prevent displacement of the sleeve in a first axial direction with respect to the second radially outward facing surface.

6. The fluid connection assembly as recited in claim 1, wherein the second plunger comprises:
a third radially outward facing surface including a second groove;
a first seal arranged in the second groove to provide a fluid tight seal between the second plunger and the second radially inward facing surface;
a third radially inward facing surface including a third groove; and
a second seal arranged in the third groove to provide a fluid tight seal between the second plunger and the shaft.

7. The fluid connection assembly as recited in claim 1, wherein the second plunger comprises a recess extending from an end thereof, and the second spring is engaged with the recess.

8. The fluid connection assembly as recited in claim 7, further comprising a stopper engaged with the second spring, the stopper including a through-bore engaged with the shaft and a plurality of through-holes circumferentially arranged around the through-bore.

9. The fluid connection assembly as recited in claim 8, wherein the stopper is secured in the second through-bore via a securing body.

10. The fluid connection assembly as recited in claim 1, wherein the first plunger comprises a stem portion and a sealing head, wherein the first spring is arranged around the stem portion.

11. The fluid connection assembly as recited in claim 10, further comprising a stopper including a through-bore slidingly engaged with the stem portion and a plurality of circumferentially spaced radially outward extending projections.

12. The fluid connection assembly as recited in claim 11, wherein the first spring is engaged with the stopper and the sealing head.

13. The fluid connection assembly as recited in claim 11, wherein the stem portion comprises an axial surface operatively arranged to engage the stopper to prevent axial displacement of the first plunger with respect to the first radially inward facing surface.

14. The fluid connection assembly as recited in claim 10, wherein the sealing head comprises:
a third radially outward facing surface arranged at an end of the first plunger;
a fourth radially outward facing surface separated from the third radially outward facing surface by a second groove; and
a seal arranged in the second groove.

15. The fluid connection assembly as recited in claim 14, wherein:
the third radially outward facing surface comprises a first diameter;
the fourth radially outward facing surface comprises a second diameter; and
the second diameter is greater than the first diameter.

16. The fluid connection assembly as recited in claim 11, wherein the stopper is removably secured to the first radially inward facing surface via a securing body.

17. The fluid connection assembly as recited in claim 1, wherein:
the first plunger comprises a recess on an end thereof;
the shaft comprises a protrusion on an end thereof; and
the protrusion is operatively arranged to engage the recess to maintain alignment of the first plunger and/or the shaft during connection.

18. The fluid connection assembly as recited in claim 1, wherein in an unconnected state:
the first plunger is sealingly engaged with the first end; and
the second plunger is sealingly engaged with the second radially inward facing surface and the shaft.

19. The fluid connection assembly as recited in claim 18, wherein in a connected state:
the first end displaces the second plunger in a first axial direction such that the second plunger is not sealingly engaged with the shaft; and
the shaft displaces the first plunger in a second axial direction, relative to the first axial direction, such that the first plunger is not sealingly engaged with the first end.

20. The fluid connection assembly as recited in claim 19, wherein in the connected state the second plunger is sealingly engaged with the second radially inward facing surface.
